(19) United States
(12) Patent Application Publication
(10) Pub. No.: US 2014/0317235 A1
(43) Pub. Date: Oct. 23, 2014

(54) Method, System and Program Product for Transmitting Software and Information Services

(71) Applicant: Yoong Siang OH, North Sydney (AU)

(72) Inventor: Yoong Siang OH, North Sydney (AU)

(21) Appl. No.: 13/865,039

(22) Filed: Apr. 17, 2013

(51) Int. Cl. H04L 29/08

(52) U.S. Cl. CPC H04L 29/0809
USPC 709/218

(57) ABSTRACT

A method, system and program product comprise transmitting a broadcast wirelessly over a localized area. The broadcast comprises at least a computer-readable message indicating an availability of an information service. The broadcast is configured to be received and interpreted by at least one receiving device within the localized area. A response is received from the at least one receiving device. A connection is established with the at least one receiving device. The information service is transmitted to the at least one receiving device.

### FEDERALLY SPONSORED RESEARCH OR DEVELOPMENT

Not applicable.

### REFERENCE TO SEQUENCE LISTING, A TABLE, OR A COMPUTER LISTING APPENDIX

Not applicable.

### COPYRIGHT NOTICE

A portion of the disclosure of this patent document contains material that is subject to copyright protection. The copyright owner has no objection to the facsimile reproduction by anyone of the patent document or patent disclosure as it appears in the Patent and Trademark Office, patent file or records, but otherwise reserves all copyright rights whatsoever.

### FIELD OF THE INVENTION

One or more embodiments of the invention generally relate to computer software. More particularly, the invention relates to transfer of computer software.

### BACKGROUND OF THE INVENTION

The following background information may present examples of specific aspects of the prior art (e.g., without limitation, approaches, facts, or common wisdom) that, while expected to be helpful to further educate the reader as to additional aspects of the prior art, is not to be construed as limiting the present invention, or any embodiments thereof, to anything stated or implied therein or inferred thereupon.

Users of electronic devices frequently download and/or transfer computer software, often in the form of applications, either from computer software providers or with other users. However, in order to do so, users are generally required to search for desired software and must generally have access to external networks or the internet.

One known solution shows proximity detection using wireless connectivity in a communication system comprising of a primary device that detects the proximity of additional remote devices. Another known solution teaches of discovery of services between wireless devices. Yet another known solution discloses of a wireless communication apparatus including a determination unit for determining whether the communication unit is in proximity to the other wireless communication apparatus. However, these solutions require user input and/or access to external networks or the internet and/or require pre-installation of software on the user device. A solution which allowed users to gain access to or transfer computer software without needing prior user input or access to external networks and/or the internet and/or any pre-installation of software on the user device would be desirable.

In view of the foregoing, it is clear that these traditional techniques are not perfect and leave room for more optimal approaches.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 illustrates an exemplary system for accessing computer software, in accordance with an embodiment of the present invention;

FIG. 2 illustrates a method for transmitting computer software, in accordance with an embodiment of the present invention;

FIG. 3 illustrates a method for transmitting and receiving computer software, in accordance with an embodiment of the present invention;

FIG. 4 illustrates a method for directing a device to an online resource, in accordance with an embodiment of the present invention;

FIG. 5 is a block diagram depicting an exemplary client/server system which may be used by an exemplary web-enabled/networked embodiment of the present invention; and

FIG. 6 illustrates a block diagram depicting a conventional client/server communication system.

Unless otherwise indicated illustrations in the figures are not necessarily drawn to scale.

### DETAILED DESCRIPTION OF SOME EMBODIMENTS

The present invention is best understood by reference to the detailed figures and description set forth herein.

Embodiments of the invention are discussed below with reference to the Figures. However, those skilled in the art will readily appreciate that the detailed description given herein with respect to these figures is for explanatory purposes as the invention extends beyond these limited embodiments. For example, it should be appreciated that those skilled in the art will, in light of the teachings of the present invention, recognize a multiplicity of alternate and suitable approaches, depending upon the needs of the particular application, to implement the functionality of any given detail described herein, beyond the particular implementation choices in the following embodiments described and shown. That is, there are numerous modifications and variations of the invention that are too numerous to be listed but that all fit within the scope of the invention. Also, singular words should be read as plural and vice versa and masculine as feminine and vice versa, where appropriate, and alternative embodiments do not necessarily imply that the two are mutually exclusive.

It is to be further understood that the present invention is not limited to the particular methodology, compounds, materials, manufacturing techniques, uses, and applications, described herein, as these may vary. It is also to be understood that the terminology used herein is used for the purpose of describing particular embodiments only, and is not intended to limit the scope of the present invention. It must be noted that as used herein and in the appended claims, the singular forms “a,” “an,” and “the” include the plural reference unless the context clearly dictates otherwise. Thus, for example, a reference to “an element” is a reference to one or more elements and includes equivalents thereof known to those skilled in the art. Similarly, for another example, a reference to “a step” or “a means” is a reference to one or more steps or means and may include sub-steps and subservient means. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

Unless defined otherwise, all technical and scientific terms used herein have the same meanings as commonly understood by one of ordinary skill in the art to which this invention belongs. Preferred methods, techniques, devices, and materials are described, although any methods, techniques, devices, or materials similar or equivalent to those described herein may be used in the practice or testing of the present invention. Structures described herein are to be understood also to refer to functional equivalents of such structures. The present invention will now be described in detail with reference to embodiments thereof as illustrated in the accompanying drawings.

From reading the present disclosure, other variations and modifications will be apparent to persons skilled in the art. Such variations and modifications may involve equivalent and other features which are already known in the art, and which may be used instead of or in addition to features already described herein.

Although Claims have been formulated in this Application to particular combinations of features, it should be understood that the scope of the disclosure of the present invention also includes any novel feature or any novel combination of features disclosed herein either explicitly or implicitly or any generalization thereof, whether or not it relates to the same invention as presently claimed in any Claim and whether or not it mitigates any or all of the same technical problems as does the present invention.

Features which are described in the context of separate embodiments may also be provided in combination in a single embodiment. Conversely, various features which are, for brevity, described in the context of a single embodiment, may also be provided separately or in any suitable subcombination. The Applicants hereby give notice that new Claims may be formulated to such features and/or combinations of such features during the prosecution of the present Application or of any further Application derived therefrom.

References to “one embodiment,” “an embodiment,” “example embodiment,” “various embodiments,” etc., may indicate that the embodiment(s) of the invention so described may include a particular feature, structure, or characteristic, but not every embodiment necessarily includes the particular feature, structure, or characteristic. Further, repeated use of the phrase “in one embodiment,” or “in an exemplary embodiment,” do not necessarily refer to the same embodiment, although they may.

Headings provided herein are for convenience and are not to be taken as limiting the disclosure in any way.

The enumerated listing of items does not imply that any or all of the items are mutually exclusive, unless expressly specified otherwise.

The terms “a”, “an” and “the” mean “one or more”, unless expressly specified otherwise.

Devices that are in communication with each other need not be in continuous communication with each other, unless expressly specified otherwise. In addition, devices that are in communication with each other may communicate directly or indirectly through one or more intermediaries.

A description of an embodiment with several components in communication with each other does not imply that all such components are required. On the contrary a variety of optional components is described to illustrate the wide variety of possible embodiments of the present invention.

As is well known to those skilled in the art many careful considerations and compromises typically must be made when designing for the optimal manufacture of a commercial implementation any system, and in particular, the embodiments of the present invention. A commercial implementation in accordance with the spirit and teachings of the present invention may configured according to the needs of the particular application, whereby any aspect(s), feature(s), function(s), result(s), component(s), approach(es), or step(s) of the teachings related to any described embodiment of the present invention may be suitably omitted, included, adapted, mixed and matched, or improved and/or optimized by those skilled in the art, using their average skills and known techniques, to achieve the desired implementation that addresses the needs of the particular application.

In the following description and claims, the terms “coupled” and “connected,” along with their derivatives, may be used. It should be understood that these terms are not intended as synonyms for each other. Rather, in particular embodiments, “connected” may be used to indicate that two or more elements are in direct physical or electrical contact with each other. “Coupled” may mean that two or more elements are in direct physical or electrical contact. However, “coupled” may also mean that two or more elements are not in direct contact with each other, but yet still cooperate or interact with each other.

A “computer” may refer to one or more apparatus and/or one or more systems that are capable of accepting a structured input, processing the structured input according to prescribed rules, and producing results of the processing as output. Examples of a computer may include: a computer; a stationary and/or portable computer; a computer having a single processor, multiple processors, or multi-core processors, which may operate in parallel and/or not in parallel; a general purpose computer; a supercomputer; a mainframe; a super mini-computer; a mini-computer; a workstation; a micro-computer; a server; a client; an interactive television; a web appliance; a telecommunications device with internet access; a hybrid combination of a computer and an interactive television; a portable computer; a tablet personal computer (PC); a personal digital assistant (PDA); a portable telephone; application-specific hardware to emulate a computer and/or software, such as, for example, a digital signal processor (DSP), a field-programmable gate array (FPGA), an application specific integrated circuit (ASIC), an application specific instruction-set processor (ASIP), a chip, chips, a system on a chip, or a chip set; a data acquisition device; an optical computer; a quantum computer; a biological computer; and generally, an apparatus that may accept data, process data according to one or more stored software programs, generate results, and typically include input, output, storage, arithmetic, logic, and control units.

Those of skill in the art will appreciate that where appropriate, some embodiments of the disclosure may be practiced in network computing environments with many types of computer system configurations, including personal computers, hand-held devices, multi-processor systems, microprocessor-based or programmable consumer electronics, network PCs, minicomputers, mainframe computers, and the like. Where appropriate, embodiments may also be practiced in distributed computing environments where tasks are performed by local and remote processing devices that are linked (either by hardwired links, wireless links, or by a combination thereof) through a communications network. In a distributed computing environment, program modules may be located in both local and remote memory storage devices.

“Software” may refer to prescribed rules to operate a computer. Examples of software may include: code segments in one or more computer-readable languages; graphical and or/textual instructions; applets; pre-compiled code; interpreted code; compiled code; and computer programs.

The example embodiments described herein can be implemented in an operating environment comprising computer-executable instructions (e.g., software) installed on a computer, in hardware, or in a combination of software and hardware. The computer-executable instructions can be written in a computer programming language or can be embodied in firmware logic. If written in a programming language conforming to a recognized standard, such instructions can be executed on a variety of hardware platforms and for interfaces to a variety of operating systems. Although not limited thereto, computer software program code for carrying out operations for aspects of the present invention can be written in any combination of one or more suitable programming languages, including an object oriented programming languages and/or conventional procedural programming languages, and/or programming languages such as, for example, Hyper text Markup Language (HTML), Dynamic HTML, Extensible Markup Language (XML), Extensible Stylesheet Language (XSL), Document Style Semantics and Specification Language (DSSSL), Cascading Style Sheets (CSS), Synchronized Multimedia Integration Language (SMIL), Wireless Markup Language (WML), Java™, Jini™, C, C++, Smalltalk, Perl, UNIX Shell, Visual Basic or Visual Basic Script, Virtual Reality Markup Language (VRML), ColdFusion™ or other compilers, assemblers, interpreters or other computer languages or platforms.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

A network is a collection of links and nodes (e.g., multiple computers and/or other devices connected together) arranged so that information may be passed from one part of the network to another over multiple links and through various nodes. Examples of networks include the Internet, the public switched telephone network, the global Telex network, computer networks (e.g., an intranet, an extranet, a local-area network, or a wide-area network), wired networks, and wireless networks.

The Internet is a worldwide network of computers and computer networks arranged to allow the easy and robust exchange of information between computer users. Hundreds of millions of people around the world have access to computers connected to the Internet via Internet Service Providers (ISPs). Content providers (e.g., website owners or operators) place multimedia information (e.g., text, graphics, audio, video, animation, and other forms of data) at specific locations on the Internet referred to as webpages. Websites comprise a collection of connected, or otherwise related, webpages. The combination of all the websites and their corresponding webpages on the Internet is generally known as the World Wide Web (WWW) or simply the Web.

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

The flowchart and block diagrams in the figures illustrate the architecture, functionality, and operation of possible implementations of systems, methods and computer program products according to various embodiments. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

Further, although process steps, method steps, algorithms or the like may be described in a sequential order, such processes, methods and algorithms may be configured to work in alternate orders. In other words, any sequence or order of steps that may be described does not necessarily indicate a requirement that the steps be performed in that order. The steps of processes described herein may be performed in any order practical. Further, some steps may be performed simultaneously.

It will be readily apparent that the various methods and algorithms described herein may be implemented by, e.g., appropriately programmed general purpose computers and computing devices. Typically a processor (e.g., a microprocessor) will receive instructions from a memory or like device, and execute those instructions, thereby performing a process defined by those instructions. Further, programs that implement such methods and algorithms may be stored and transmitted using a variety of known media.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article.

The functionality and/or the features of a device may be alternatively embodied by one or more other devices which are not explicitly described as having such functionality/features. Thus, other embodiments of the present invention need not include the device itself.

The term “computer-readable medium” as used herein refers to any medium that participates in providing data (e.g., instructions) which may be read by a computer, a processor or a like device. Such a medium may take many forms, including but not limited to, non-volatile media, volatile media, and transmission media. Non-volatile media include, for example, optical or magnetic disks and other persistent memory. Volatile media include dynamic random access memory (DRAM), which typically constitutes the main memory. Transmission media include coaxial cables, copper wire and fiber optics, including the wires that comprise a system bus coupled to the processor. Transmission media may include or convey acoustic waves, light waves and electromagnetic emissions, such as those generated during radio frequency (RF) and infrared (IR) data communications. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, a carrier wave as described hereinafter, or any other medium from which a computer can read.

Various forms of computer readable media may be involved in carrying sequences of instructions to a processor. For example, sequences of instruction (i) may be delivered from RAM to a processor, (ii) may be carried over a wireless transmission medium, and/or (iii) may be formatted according to numerous formats, standards or protocols, such as Bluetooth, TDMA, CDMA, 3G.

Where databases are described, it will be understood by one of ordinary skill in the art that (i) alternative database structures to those described may be readily employed, (ii) other memory structures besides databases may be readily employed. Any schematic illustrations and accompanying descriptions of any sample databases presented herein are exemplary arrangements for stored representations of information. Any number of other arrangements may be employed besides those suggested by the tables shown. Similarly, any illustrated entries of the databases represent exemplary information only; those skilled in the art will understand that the number and content of the entries can be different from those illustrated herein. Further, despite any depiction of the databases as tables, an object-based model could be used to store and manipulate the data types of the present invention and likewise, object methods or behaviors can be used to implement the processes of the present invention.

A “computer system” may refer to a system having one or more computers, where each computer may include a computer-readable medium embodying software to operate the computer or one or more of its components. Examples of a computer system may include: a distributed computer system for processing information via computer systems linked by a network; two or more computer systems connected together via a network for transmitting and/or receiving information between the computer systems; a computer system including two or more processors within a single computer; and one or more apparatuses and/or one or more systems that may accept data, may process data in accordance with one or more stored software programs, may generate results, and typically may include input, output, storage, arithmetic, logic, and control units.

A “network” may refer to a number of computers and associated devices that may be connected by communication facilities. A network may involve permanent connections such as cables or temporary connections such as those made through telephone or other communication links. A network may further include hard-wired connections (e.g., coaxial cable, twisted pair, optical fiber, waveguides, etc.) and/or wireless connections (e.g., radio frequency waveforms, free-space optical waveforms, acoustic waveforms, etc.). Examples of a network may include: an internet, such as the Internet; an intranet; a local area network (LAN); a wide area network (WAN); and a combination of networks, such as an internet and an intranet.

As used herein, the “client-side” application should be broadly construed to refer to an application, a page associated with that application, or some other resource or function invoked by a client-side request to the application. A “browser” as used herein is not intended to refer to any specific browser (e.g., Internet Explorer, Safari, FireFox, or the like), but should be broadly construed to refer to any client-side rendering engine that can access and display Internet-accessible resources. A “rich” client typically refers to a non-HTTP based client-side application, such as an SSH or CFIS client. Further, while typically the client-server interactions occur using HTTP, this is not a limitation either. The client server interaction may be formatted to conform to the Simple Object Access Protocol (SOAP) and travel over HTTP (over the public Internet), FTP, or any other reliable transport mechanism (such as IBM® MQSeries® technologies and CORBA, for transport over an enterprise intranet) may be used. Any application or functionality described herein may be implemented as native code, by providing hooks into another application, by facilitating use of the mechanism as a plug-in, by linking to the mechanism, and the like.

Exemplary networks may operate with any of a number of protocols, such as Internet protocol (IP), asynchronous transfer mode (ATM), and/or synchronous optical network (SONET), user datagram protocol (UDP), IEEE 802.x, etc.

Embodiments of the present invention may include apparatuses for performing the operations disclosed herein. An apparatus may be specially constructed for the desired purposes, or it may comprise a general-purpose device selectively activated or reconfigured by a program stored in the device.

Embodiments of the invention may also be implemented in one or a combination of hardware, firmware, and software. They may be implemented as instructions stored on a machine-readable medium, which may be read and executed by a computing platform to perform the operations described herein.

More specifically, as will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

In the following description and claims, the terms “computer program medium” and “computer readable medium” may be used to generally refer to media such as, but not limited to, removable storage drives, a hard disk installed in hard disk drive, and the like. These computer program products may provide software to a computer system. Embodiments of the invention may be directed to such computer program products.

An algorithm is here, and generally, considered to be a self-consistent sequence of acts or operations leading to a desired result. These include physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers or the like. It should be understood, however, that all of these and similar terms are to be associated with the appropriate physical quantities and are merely convenient labels applied to these quantities.

Unless specifically stated otherwise, and as may be apparent from the following description and claims, it should be appreciated that throughout the specification descriptions utilizing terms such as “processing,” “computing,” “calculating,” “determining,” or the like, refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices.

In a similar manner, the term “processor” may refer to any device or portion of a device that processes electronic data from registers and/or memory to transform that electronic data into other electronic data that may be stored in registers and/or memory. A “computing platform” may comprise one or more processors.

Embodiments within the scope of the present disclosure may also include tangible and/or non-transitory computer-readable storage media for carrying or having computer-executable instructions or data structures stored thereon. Such non-transitory computer-readable storage media can be any available media that can be accessed by a general purpose or special purpose computer, including the functional design of any special purpose processor as discussed above. By way of example, and not limitation, such non-transitory computer-readable media can include RAM, ROM, EEPROM, CD-ROM or other optical disk storage, magnetic disk storage or other magnetic storage devices, or any other medium which can be used to carry or store desired program code means in the form of computer-executable instructions, data structures, or processor chip design. When information is transferred or provided over a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable media.

While a non-transitory computer readable medium includes, but is not limited to, a hard drive, compact disc, flash memory, volatile memory, random access memory, magnetic memory, optical memory, semiconductor based memory, phase change memory, optical memory, periodically refreshed memory, and the like; the non-transitory computer readable medium, however, does not include a pure transitory signal per se; i.e., where the medium itself is transitory.

It is to be understood that any exact measurements/dimensions or particular construction materials indicated herein are solely provided as examples of suitable configurations and are not intended to be limiting in any way. Depending on the needs of the particular application, those skilled in the art will readily recognize, in light of the following teachings, a multiplicity of suitable alternative implementation details.

Embodiments of the present invention may provide means and methods for transferring computer software.

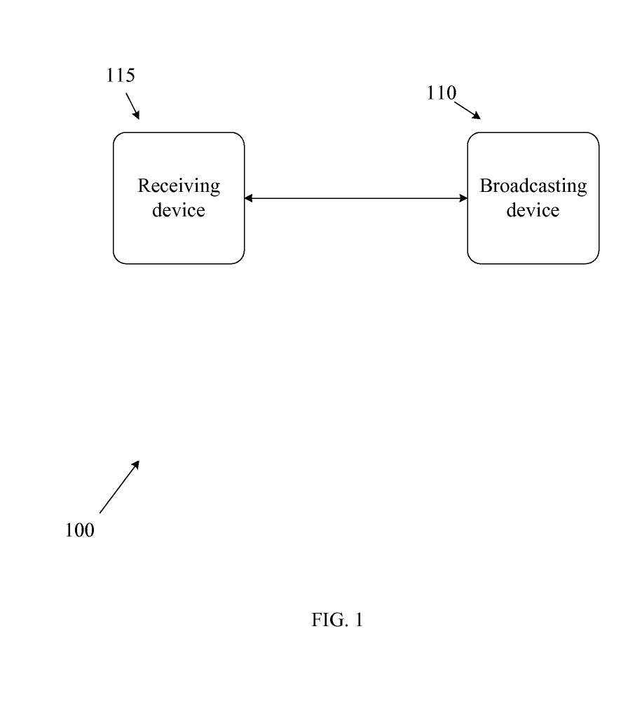

FIG. 1 illustrates an exemplary system for accessing computer software, in accordance with an embodiment of the present invention. In the present embodiment, a broadcasting device 110 may transfer computer software to a receiving device 115. The broadcasting device 110 may be a server, router, smartphone, tablet, laptop computer, PC, PDA, television or any device capable of transmitting computer software. The receiving device 115 may be a smartphone, tablet, laptop computer, PC, PDA, television or any other device capable of receiving computer software. In many embodiments, computer software may be transmitted between the broadcasting device 110 and the receiving device 115 through wireless means. In some embodiments, the computer software to be transmitted by the broadcasting device 110 may be stored locally on the broadcasting device 110, or in an external memory resource that is connected to the broadcasting device 110, and thus the broadcasting device 110 may transmit computer software without accessing cellular or external networks and/or without an internet connection. In other embodiments, the broadcasting device 110 may access any relevant networks and/or the internet in order to provide the software, or any update to the software, to any such receiving devices 115. In some embodiments, the receiving device 115 may transfer software to other devices. In some embodiments, software transferred to a receiving device 115 may be a copy of software on a broadcasting device 110. In at least some embodiments, transferred computer software may be in the form of applications which may be used by, without limitation, smartphones, tablets, laptop computers, PCs, PDAs or televisions. In alternative embodiments, transfers of computer software may be performed through wired networks of devices. In some embodiments, a plurality of devices may act as both a broadcasting device 110 and a receiving device 115 to broadcast and transmit software and/or information amongst the device for software and/or information to be exchanged between the devices.

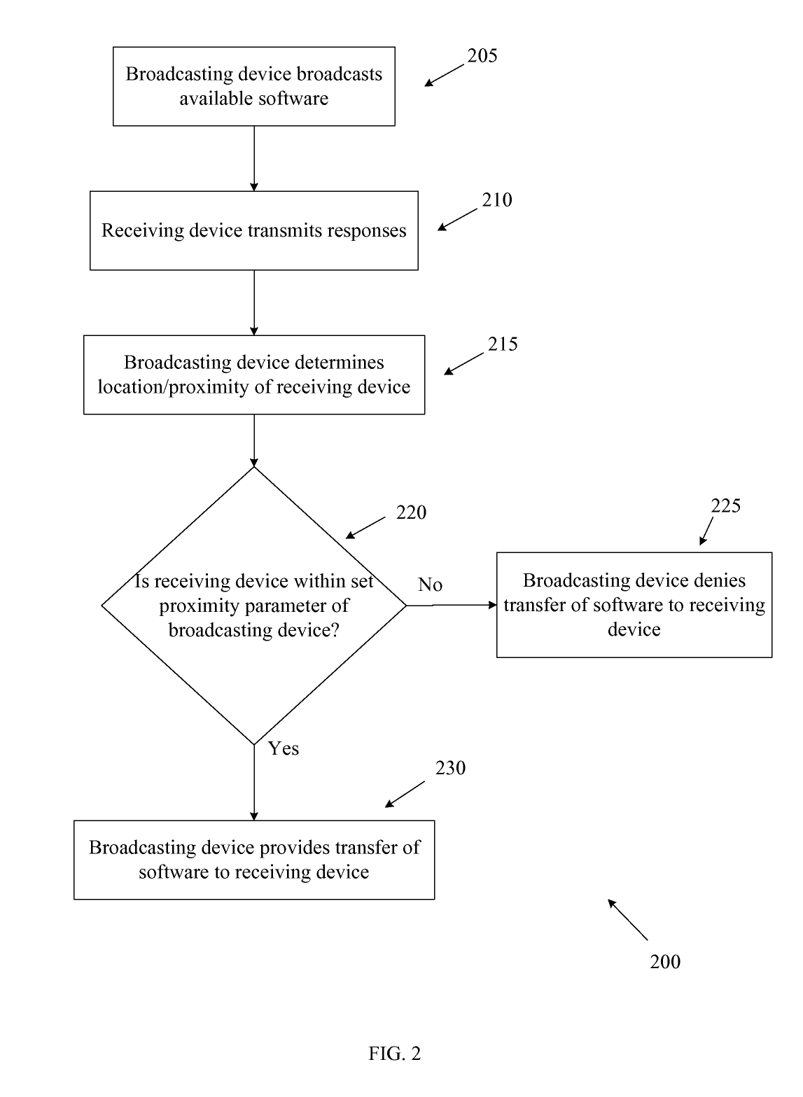

FIG. 2 illustrates a method for transmitting computer software, in accordance with an embodiment of the present invention. In the present embodiment, a broadcasting device 110 may broadcast a provision of available computer software in a step 205. In some embodiments, the broadcasting device 110 may broadcast to any device within a specified proximity to the broadcasting device 110. In alternative embodiments, the broadcasting device 110 may broadcast to an unlimited area. In the present embodiment, a receiving device 115 may receive broadcasts and transmit responses to the broadcasting device 110 in a step 210. The broadcasting device 110 may determine a location of the receiving device 115 in a step 215. In some embodiments, the determined location of the receiving device 115 may be a proximity of the receiving device 115 to the broadcasting device 110. In some of these embodiments, the proximity of the receiving device 115 to the broadcasting device 110 may be determined by a time of broadcast and/or a time of response. In alternative embodiments, locations of the receiving device 115 and/or the broadcasting device 110 may be determined by a global positioning system (GPS) or other locating means. In the present embodiment, the broadcasting device 110 may use the location of the receiving device 115 to determine whether the receiving device 115 is within a determined proximity from the broadcasting device in a step 220. If the receiving device 115 is beyond the determined proximity from the broadcasting device 110, the broadcasting device 110 may deny any transfers to the receiving device 115 in a step 225. If the receiving device 115 is within the determined proximity from the broadcasting device 110, the broadcasting device 110 may allow transfer of software to the receiving device 115 in a step 230.

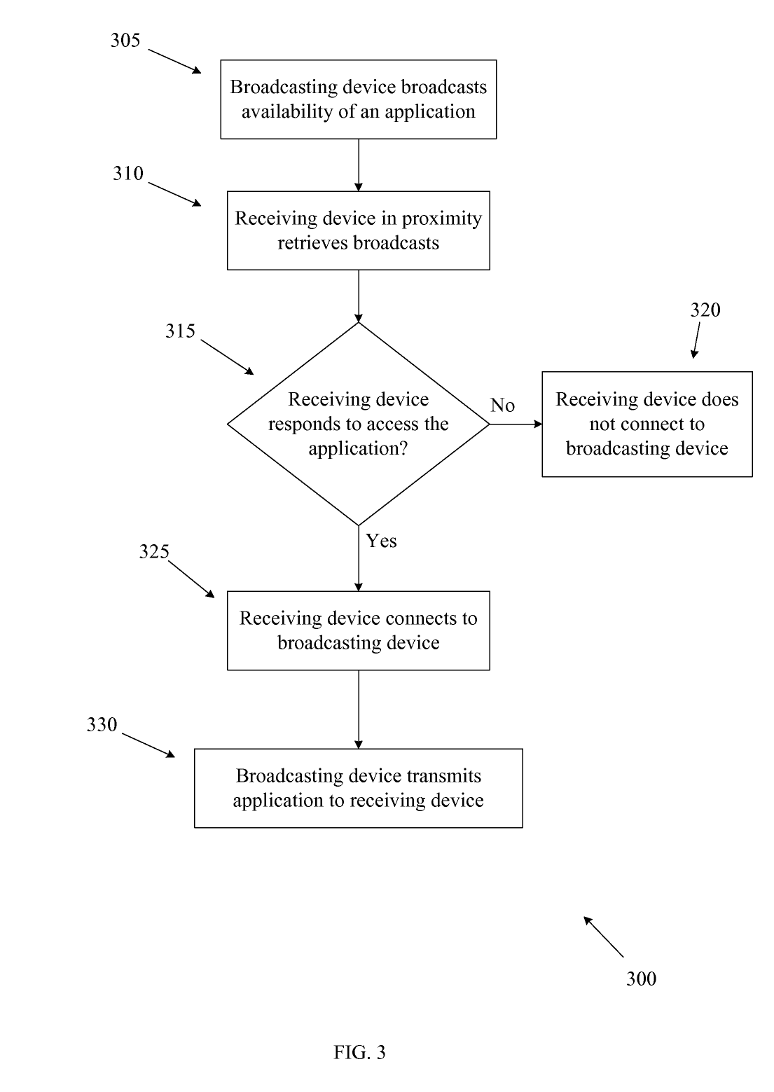

FIG. 3 illustrates a method for transmitting and receiving computer software, in accordance with an embodiment of the present invention. In the present embodiment, a broadcasting device 110 may broadcast an availability of an application or other computer software in a step 305. In some embodiments, the broadcasting device 110 may broadcast through wireless means. A receiving device 115 may receive the broadcasts from the broadcasting device in a step 310. In some embodiments, receiving devices 115 may need to be within a determined proximity of the broadcasting device 110 in order to retrieve the broadcasts. In some other embodiments, receiving devices 115 may be able to receive broadcast without pre-configuration, installation, or any other prior access to broadcasted computer software. In the present embodiment, the receiving device 115 may determine whether to access any broadcasted software in a step 315. In some embodiments, a user of the receiving device 115 may manually decide whether to access broadcasted software. In alternative embodiments, the receiving device 115 may be automatically configured to filter broadcasted software. If the receiving device 115 denies access to broadcasted software, the receiving device 115 may not be connected to the broadcasting device in a step 320. If the receiving device 115 allows access to broadcasted software, the receiving device 115 may connect to the broadcasting device 110 in a step 325. The broadcasting device 110 may then transmit allowed software to the receiving device 115 in a step 330.

In a non-limiting example, a broadcasting device 110 may be a server owned by a company which designs and distributes applications that may be used by, without limitation, smartphones, tablets, and laptop computers. The server may be configured to allow wireless downloads of the applications stored locally on the server. A first user may have a smartphone which may act as a receiving device 115. While within the area set by the server, the first user may be alerted of the availability of the application on the server through the server's wireless broadcasts to the user's smartphone of such availability. The first user may then have the option of accepting the application, in which case the first user's smartphone and the server would be connected, or rejecting the application, in which case the first user's smartphone and the server would not be connected. If the first user accepts the application, the first user's smartphone will download the application from the server. The first user may have access to the application without needing to input a name of the application, description of the application, or any other information. The first user may then also wirelessly broadcast the availability of the application to other users within an area determined by the first user. A second user may also own a smartphone which may act as another receiving device 115 for the transmission of the application from the first user to such second user.

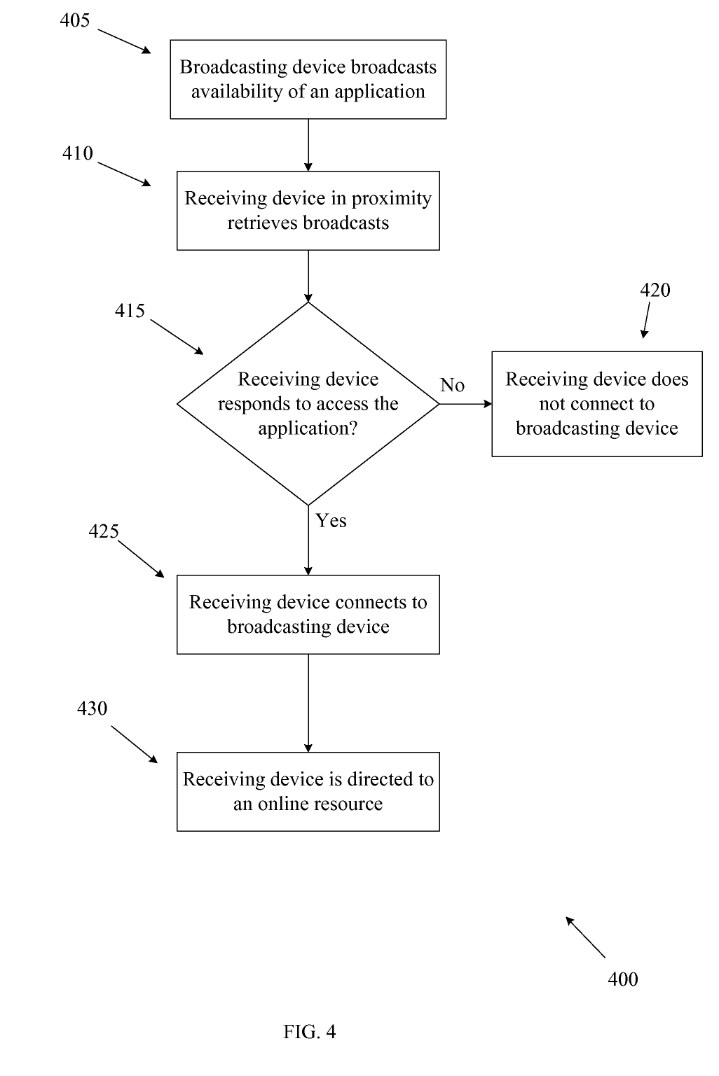

FIG. 4 illustrates a method for directing a device to an online resource, in accordance with an embodiment of the present invention. In the present embodiment, a broadcasting device 110 may broadcast an availability of an application or other computer software in a step 405. A receiving device 115 may receive the broadcasts from the broadcasting device in a step 410. The receiving device 115 may determine whether to access any broadcasted software in a step 415. If the receiving device 115 denies access to broadcasted software, the receiving device 115 may not be connected to the broadcasting device in a step 420. If the receiving device 115 allows access to broadcasted software, the receiving device 115 may connect to the broadcasting device 110 in a step 425. Software may then be transferred to the receiving device 115 which may cause the receiving device 115 to be redirected to an online resource in a step 430. In some embodiments, redirection to an online resource may require access to a cellular or external network and/or the internet. In at least some embodiments, redirection to an online resource may be facilitated through termination of a wireless connection between the receiving device 115 and the broadcasting device 110 before the receiving device 115 may be directed to the online resource. In alternative embodiments, redirection may be performed without terminating a connection between devices. In some embodiments, redirection to an online resource may be through triggering an existing software present on the receiving device. In other alternative embodiments, broadcasts may contain messages directing receivers to visit internet web pages or other sources in order to access software. In a non-limiting example, the broadcasting device may be a wireless router and the receiving device may be a smartphone. Upon connection to the broadcasting device, the wireless router transmits a software, or some code, that instructs the smartphone to execute an existing application on the smartphone, either by default or has been previously installed by the user, that connects to the online resource.

In some embodiments, a broadcasting device 110 may be able to store more than one application or software program at any given time. In at least some of these embodiments, each individual software program may have an individual broadcast.

In many embodiments, the broadcasting device 110 and/or receiving device 115 may be compatible with 802.XX specification. Embodiments of the present invention may be functional with any devices, including, without limitation, devices compatible with 802.XX specification.

In other embodiments, a broadcasting device 110 may have functionality to determine whether to provide or deliver software to a receiving device 115. The broadcasting device 110 may determine whether to provide access based on a variety of factors, including, without limitation, signal strength of a wireless connection with the receiving device 115, distance between the broadcasting device 110 and the receiving device 115, identity of a user of the receiving device 115, identity of the receiving device 115, and time. Any factors may be adjusted by users of the broadcasting device 110. In alternative embodiments, a user of a broadcasting device 110 may manually choose whether to allow individual receiving devices. In certain embodiments, the broadcasting device may, based on a variety of factors which may or may not be the same as the abovementioned, provide users of the receiving device 115 differentiated access to various versions of the software.

In some embodiments, transferred software may have interactive features that may require a user to provide input into the software. In some of these embodiments, data may be exchanged between a broadcasting device 110 and a receiving device 115. In at least some of these embodiments, the software may store data on the receiving device 110, and other software programs provided or delivered by broadcasting devices 110 may retrieve such data from the receiving device 110.

In other embodiments, a receiving device 115 may be unable to receive broadcasts until certain software may have been installed on the receiving device 115.

In still other embodiments, a broadcasting device 110 may promptly transmit software to a receiving device 115 after the receiving device 115 may have connected to the broadcasting device 110. In some of these embodiments, the receiving device 115 may be made to display the software automatically without requiring a user of the receiving device 115 to perform any input. This may require certain software to be installed on the receiving device in certain embodiments. In other embodiments, users may be required to perform input in order to run or display the software. In a non-limiting example, a user may be required to start a browser in order for an application to be run or displayed.

Embodiments of the present invention may become extensions to electronic database systems, and information on a database may be served by a broadcasting device 110 into an area. In a non-limiting example, the broadcasting device 110 is connected to the library catalog electronic database and the broadcasting device 110 broadcasts the availability of the library catalog wirelessly to all receiving devices in the proximity and within the library. When users of receiving devices that wish to access the library catalog connect to the broadcasting device 110, the broadcasting device transmits to the receiving device a software that allows the user of the receiving device to access and search the library catalog.

Some embodiments may also be coupled with other systems. In a non-limiting example, an embodiment of the present invention may be coupled with an announcement system so that after an announcement is made, a broadcasting device 110 may then broadcast software pertaining to the announcement or further details which the announcement may have referred to. In a non-limiting example, the broadcasting device 110 may be in use in a stadium and once an announcement is made in the stadium, the software containing the transcript of the announcement and/or the actual audio file of the announcement may be transmitted by the broadcasting device to any receiving devices in the vicinity of the stadium, once the receiving devices respond and connect to the broadcasting device.

Other embodiments may be combined with electronic systems in which a user may control actions of an electronic system. In a non-limiting example, a broadcasting device 110 may be connected to an electronic door system, and a user may be required to use a receiving device 115 to connect to the broadcasting device 110, coupled to the door, to open a door.

Still other embodiments may be incorporated to offer navigation assistance. In a non-limiting example, an embodiment may be incorporated to offer a shopping mall directory or any other venue or place of interest. In the present non-limiting example, visitors of the mall may access the directory by means of wireless receiving device. In another non-limiting example, embodiments may be combined with a device's location service to provide an accessible local map for navigation.

Yet other embodiments may be incorporated to provide information points which may include, without limitation, multimedia such as videos, pictures, and sounds for displays, exhibits, or articles of interest in museums and other areas of interest. In a non-limiting example, the broadcasting device 110 may be placed in a museum and stores software containing an audio file introducing a particular exhibit in the museum, The broadcasting device broadcasts the availability of the software and any receiving devices in the vicinity may respond and connect to the broadcasting device for the software to be transmitted to the receiving device, and then for the audio file to be played.

Other embodiments may be incorporated to provide, without limitation, wirelessly accessible menus, catalogs, forms for registration, forms for applications, forms for feedback, and voting and/or polling functions. In a non-limiting example, the broadcasting device 110 may be used in a departmental store to collect feedback of service in the departmental store. The broadcasting device broadcasts the availability of the software to collect customer feedback on service. Users of receiving devices in the vicinity can respond and connect to the broadcasting device for the software to be transmitted to the receiving device. Once the software is transmitted, it loads on the user's receiving device and allows the user to input the text fields. If the user of the receiving device has used a similar software before in either the same departmental store or a different departmental store using the same software, the software may store and/or access certain data on the user's receiving device to pre-populate certain text fields, such as name of the user.

Still other embodiments may be incorporated to provide electronic queue systems. In a non-limiting example, a user of a receiving device joins the queue and connects to the broadcasting device 110 for the broadcasting device to transmit software to the receiving device to generate a queue number. The software may collect and/or access information of the user, such that when the user's queue number is called, the user's receiving device may be alerted.

Yet other embodiments may be incorporated to provide convenient redirection service by which users may easily and conveniently be directed to web pages. In a non-limiting example, the broadcasting device 110 may be connected to an advertising billboard. There may be web pages and websites being referred to on the advertisement shown on the advertising billboard. The broadcasting device broadcasts the availability of a software to receiving devices in proximity. Upon connection by a receiving device to the broadcasting device, the broadcasting device will transmit software that will redirect the receiving device to a webpage or website or any such online resource. In some embodiments, the broadcasting device 110 may be configured, either through pre-configuration or live-configuration, such that the software being transmitted by the broadcasting device 110 to any receiving devices 115 is modified or altered. In a non-limiting example, the broadcasting device 110 may be connected to an digital advertising billboard, which periodically shows different advertisements. As the digital advertising billboard shows a different advertisement, the software being transmitted by the broadcasting device 110 is also modified such that the relevant software is transmitted to the receiving devices 115 at the relevant time.

Other embodiments may be incorporated to provide wireless broadcast information service in transport hubs where transport and transit information may be broadcast, including, without limitation, train stations, bus terminals, and airports.

Those skilled in the art will readily recognize, in light of and in accordance with the teachings of the present invention, that any of the foregoing steps and/or system modules may be suitably replaced, reordered, removed and additional steps and/or system modules may be inserted depending upon the needs of the particular application, and that the systems of the foregoing embodiments may be implemented using any of a wide variety of suitable processes and system modules, and is not limited to any particular computer hardware, software, middleware, firmware, microcode and the like. For any method steps described in the present application that can be carried out on a computing machine, a typical computer system can, when appropriately configured or designed, serve as a computer system in which those aspects of the invention may be embodied.

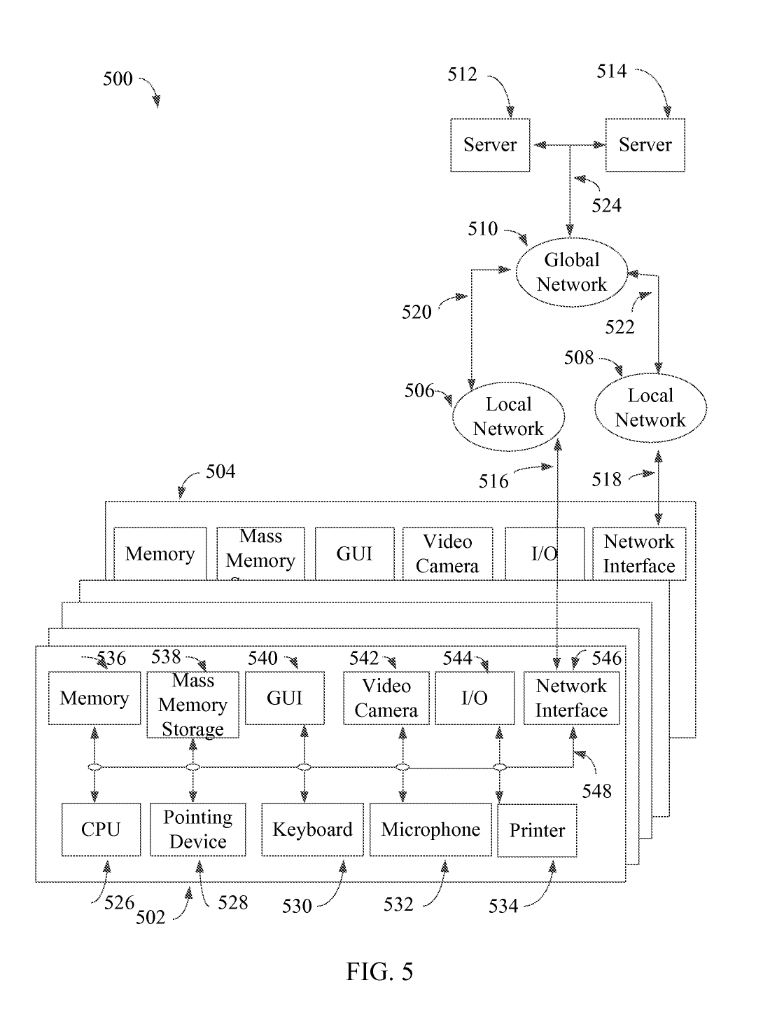

FIG. 5 is a block diagram depicting an exemplary client/server system which may be used by an exemplary web-enabled/networked embodiment of the present invention.

A communication system 500 includes a multiplicity of clients with a sampling of clients denoted as a client 502 and a client 504, a multiplicity of local networks with a sampling of networks denoted as a local network 506 and a local network 508, a global network 510 and a multiplicity of servers with a sampling of servers denoted as a server 512 and a server 514.

Client 502 may communicate bi-directionally with local network 506 via a communication channel 516. Client 504 may communicate bi-directionally with local network 508 via a communication channel 518. Local network 506 may communicate bi-directionally with global network 510 via a communication channel 520. Local network 508 may communicate bi-directionally with global network 510 via a communication channel 522. Global network 510 may communicate bi-directionally with server 512 and server 514 via a communication channel 524. Server 512 and server 514 may communicate bi-directionally with each other via communication channel 524. Furthermore, clients 502, 504, local networks 506, 508, global network 510 and servers 512, 514 may each communicate bi-directionally with each other.

In one embodiment, global network 510 may operate as the Internet. It will be understood by those skilled in the art that communication system 500 may take many different forms. Non-limiting examples of forms for communication system 500 include local area networks (LANs), wide area networks (WANs), wired telephone networks, wireless networks, or any other network supporting data communication between respective entities.

Clients 502 and 504 may take many different forms. Non-limiting examples of clients 502 and 504 include personal computers, personal digital assistants (PDAs), cellular phones and smartphones.

Client 502 includes a CPU 526, a pointing device 528, a keyboard 530, a microphone 532, a printer 534, a memory 536, a mass memory storage 538, a GUI 540, a video camera 542, an input/output interface 544 and a network interface 546.

CPU 526, pointing device 528, keyboard 530, microphone 532, printer 534, memory 536, mass memory storage 538, GUI 540, video camera 542, input/output interface 544 and network interface 546 may communicate in a unidirectional manner or a bi-directional manner with each other via a communication channel 548. Communication channel 548 may be configured as a single communication channel or a multiplicity of communication channels.

CPU 526 may be comprised of a single processor or multiple processors. CPU 526 may be of various types including micro-controllers (e.g., with embedded RAM/ROM) and microprocessors such as programmable devices (e.g., RISC or SISC based, or CPLDs and FPGAs) and devices not capable of being programmed such as gate array ASICs (Application Specific Integrated Circuits) or general purpose microprocessors.

As is well known in the art, memory 536 is used typically to transfer data and instructions to CPU 526 in a bi-directional manner. Memory 536, as discussed previously, may include any suitable computer-readable media, intended for data storage, such as those described above excluding any wired or wireless transmissions unless specifically noted. Mass memory storage 538 may also be coupled bi-directionally to CPU 526 and provides additional data storage capacity and may include any of the computer-readable media described above. Mass memory storage 538 may be used to store programs, data and the like and is typically a secondary storage medium such as a hard disk. It will be appreciated that the information retained within mass memory storage 538, may, in appropriate cases, be incorporated in standard fashion as part of memory 536 as virtual memory.

CPU 526 may be coupled to GUI 540. GUI 540 enables a user to view the operation of computer operating system and software. CPU 526 may be coupled to pointing device 528. Non-limiting examples of pointing device 528 include computer mouse, trackball and touchpad. Pointing device 528 enables a user with the capability to maneuver a computer cursor about the viewing area of GUI 540 and select areas or features in the viewing area of GUI 540. CPU 526 may be coupled to keyboard 530. Keyboard 530 enables a user with the capability to input alphanumeric textual information to CPU 526. CPU 526 may be coupled to microphone 532. Microphone 532 enables audio produced by a user to be recorded, processed and communicated by CPU 526. CPU 526 may be connected to printer 534. Printer 534 enables a user with the capability to print information to a sheet of paper. CPU 526 may be connected to video camera 542. Video camera 542 enables video produced or captured by user to be recorded, processed and communicated by CPU 526.

CPU 526 may also be coupled to input/output interface 544 that connects to one or more input/output devices such as such as CD-ROM, video monitors, track balls, mice, keyboards, microphones, touch-sensitive displays, transducer card readers, magnetic or paper tape readers, tablets, styluses, voice or handwriting recognizers, or other well-known input devices such as, of course, other computers.

Finally, CPU 526 optionally may be coupled to network interface 546 which enables communication with an external device such as a database or a computer or telecommunications or internet network using an external connection shown generally as communication channel 516, which may be implemented as a hardwired or wireless communications link using suitable conventional technologies. With such a connection, CPU 526 might receive information from the network, or might output information to a network in the course of performing the method steps described in the teachings of the present invention.

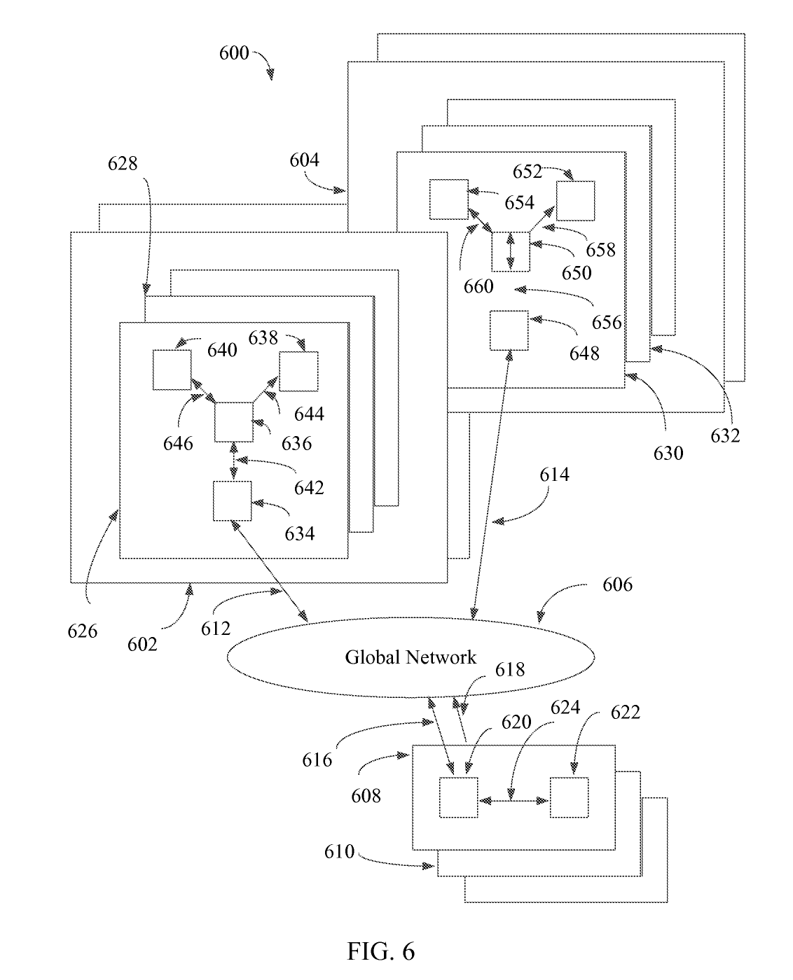

FIG. 6 illustrates a block diagram depicting a conventional client/server communication system.

A communication system 600 includes a multiplicity of networked regions with a sampling of regions denoted as a network region 602 and a network region 604, a global network 606 and a multiplicity of servers with a sampling of servers denoted as a server device 608 and a server device 610.

Network region 602 and network region 604 may operate to represent a network contained within a geographical area or region. Non-limiting examples of representations for the geographical areas for the networked regions may include postal zip codes, telephone area codes, states, counties, cities and countries. Elements within network region 602 and 604 may operate to communicate with external elements within other networked regions or within elements contained within the same network region.

In some implementations, global network 606 may operate as the Internet. It will be understood by those skilled in the art that communication system 600 may take many different forms. Non-limiting examples of forms for communication system 600 include local area networks (LANs), wide area networks (WANs), wired telephone networks, cellular telephone networks or any other network supporting data communication between respective entities via hardwired or wireless communication networks. Global network 606 may operate to transfer information between the various networked elements.

Server device 608 and server device 610 may operate to execute software instructions, store information, support database operations and communicate with other networked elements. Non-limiting examples of software and scripting languages which may be executed on server device 608 and server device 610 include C, C++, C# and Java.

Network region 602 may operate to communicate bi-directionally with global network 606 via a communication channel 612. Network region 604 may operate to communicate bi-directionally with global network 606 via a communication channel 614. Server device 608 may operate to communicate bi-directionally with global network 606 via a communication channel 616. Server device 610 may operate to communicate bi-directionally with global network 606 via a communication channel 618. Network region 602 and 604, global network 606 and server devices 608 and 610 may operate to communicate with each other and with every other networked device located within communication system 600.

Server device 608 includes a networking device 620 and a server 622. Networking device 620 may operate to communicate bi-directionally with global network 606 via communication channel 616 and with server 622 via a communication channel 624. Server 622 may operate to execute software instructions and store information.

Network region 602 includes a multiplicity of clients with a sampling denoted as a client 626 and a client 628. Client 626 includes a networking device 634, a processor 636, a GUI 638 and an interface device 640. Non-limiting examples of devices for GUI 638 include monitors, televisions, cellular telephones, smartphones and PDAs (Personal Digital Assistants). Non-limiting examples of interface device 640 include pointing device, mouse, trackball, scanner and printer. Networking device 634 may communicate bi-directionally with global network 606 via communication channel 612 and with processor 636 via a communication channel 642. GUI 638 may receive information from processor 636 via a communication channel 644 for presentation to a user for viewing. Interface device 640 may operate to send control information to processor 636 and to receive information from processor 636 via a communication channel 646. Network region 604 includes a multiplicity of clients with a sampling denoted as a client 630 and a client 632. Client 630 includes a networking device 648, a processor 650, a GUI 652 and an interface device 654. Non-limiting examples of devices for GUI 638 include monitors, televisions, cellular telephones, smartphones and PDAs (Personal Digital Assistants). Non-limiting examples of interface device 640 include pointing devices, mouse, trackballs, scanners and printers. Networking device 648 may communicate bi-directionally with global network 606 via communication channel 614 and with processor 650 via a communication channel 656. GUI 652 may receive information from processor 650 via a communication channel 658 for presentation to a user for viewing. Interface device 654 may operate to send control information to processor 650 and to receive information from processor 650 via a communication channel 660.

For example, consider the case where a user interfacing with client 626 may want to execute a networked application. A user may enter the IP (Internet Protocol) address for the networked application using interface device 640. The IP address information may be communicated to processor 636 via communication channel 646. Processor 636 may then communicate the IP address information to networking device 634 via communication channel 642. Networking device 634 may then communicate the IP address information to global network 606 via communication channel 612. Global network 606 may then communicate the IP address information to networking device 620 of server device 608 via communication channel 616. Networking device 620 may then communicate the IP address information to server 622 via communication channel 624. Server 622 may receive the IP address information and after processing the IP address information may communicate return information to networking device 620 via communication channel 624. Networking device 620 may communicate the return information to global network 606 via communication channel 616. Global network 606 may communicate the return information to networking device 634 via communication channel 612. Networking device 634 may communicate the return information to processor 636 via communication channel 642. Processor 666 may communicate the return information to GUI 668 via communication channel 644. User may then view the return information on GUI 638.

It will be further apparent to those skilled in the art that at least a portion of the novel method steps and/or system components of the present invention may be practiced and/or located in location(s) possibly outside the jurisdiction of the United States of America (USA), whereby it will be accordingly readily recognized that at least a subset of the novel method steps and/or system components in the foregoing embodiments must be practiced within the jurisdiction of the USA for the benefit of an entity therein or to achieve an object of the present invention. Thus, some alternate embodiments of the present invention may be configured to comprise a smaller subset of the foregoing means for and/or steps described that the applications designer will selectively decide, depending upon the practical considerations of the particular implementation, to carry out and/or locate within the jurisdiction of the USA. For example, any of the foregoing described method steps and/or system components which may be performed remotely over a network (e.g., without limitation, a remotely located server) may be performed and/or located outside of the jurisdiction of the USA while the remaining method steps and/or system components (e.g., without limitation, a locally located client) of the forgoing embodiments are typically required to be located/performed in the USA for practical considerations. In client-server architectures, a remotely located server typically generates and transmits required information to a US based client, for use according to the teachings of the present invention. Depending upon the needs of the particular application, it will be readily apparent to those skilled in the art, in light of the teachings of the present invention, which aspects of the present invention can or should be located locally and which can or should be located remotely. Thus, for any claims construction of the following claim limitations that are construed under 35 USC §112 (6) it is intended that the corresponding means for and/or steps for carrying out the claimed function are the ones that are locally implemented within the jurisdiction of the USA, while the remaining aspect(s) performed or located remotely outside the USA are not intended to be construed under 35 USC §112 (6). In some embodiments, the methods and/or system components which may be located and/or performed remotely include, without limitation: transmitting and receiving software.

It is noted that according to USA law, all claims must be set forth as a coherent, cooperating set of limitations that work in functional combination to achieve a useful result as a whole. Accordingly, for any claim having functional limitations interpreted under 35 USC §112 (6) where the embodiment in question is implemented as a client-server system with a remote server located outside of the USA, each such recited function is intended to mean the function of combining, in a logical manner, the information of that claim limitation with at least one other limitation of the claim. For example, in client-server systems where certain information claimed under 35 USC §112 (6) is/(are) dependent on one or more remote servers located outside the USA, it is intended that each such recited function under 35 USC §112 (6) is to be interpreted as the function of the local system receiving the remotely generated information required by a locally implemented claim limitation, wherein the structures and or steps which enable, and breathe life into the expression of such functions claimed under 35 USC §112 (6) are the corresponding steps and/or means located within the jurisdiction of the USA that receive and deliver that information to the client (e.g., without limitation, client-side processing and transmission networks in the USA). When this application is prosecuted or patented under a jurisdiction other than the USA, then “USA” in the foregoing should be replaced with the pertinent country or countries or legal organization(s) having enforceable patent infringement jurisdiction over the present application, and “35 USC §112 (6)” should be replaced with the closest corresponding statute in the patent laws of such pertinent country or countries or legal organization(s).

All the features disclosed in this specification, including any accompanying abstract and drawings, may be replaced by alternative features serving the same, equivalent or similar purpose, unless expressly stated otherwise. Thus, unless expressly stated otherwise, each feature disclosed is one example only of a generic series of equivalent or similar features.

Having fully described at least one embodiment of the present invention, other equivalent or alternative methods of implementing computer software according to the present invention will be apparent to those skilled in the art. Various aspects of the invention have been described above by way of illustration, and the specific embodiments disclosed are not intended to limit the invention to the particular forms disclosed. The particular implementation of the computer software may vary depending upon the particular context or application. By way of example, and not limitation, the computer software described in the foregoing were principally directed to transfer of computer software implementations; however, similar techniques may instead be applied to wired networks, which implementations of the present invention are contemplated as within the scope of the present invention. The invention is thus to cover all modifications, equivalents, and alternatives falling within the spirit and scope of the following claims. It is to be further understood that not all of the disclosed embodiments in the foregoing specification will necessarily satisfy or achieve each of the objects, advantages, or improvements described in the foregoing specification.

Claim elements and steps herein may have been numbered and/or lettered solely as an aid in readability and understanding. Any such numbering and lettering in itself is not intended to and should not be taken to indicate the ordering of elements and/or steps in the claims.

The corresponding structures, materials, acts, and equivalents of all means or step plus function elements in the claims below are intended to include any structure, material, or act for performing the function in combination with other claimed elements as specifically claimed.

The Abstract is provided to comply with 37 C.F.R. Section 1.72(b) requiring an abstract that will allow the reader to ascertain the nature and gist of the technical disclosure. It is submitted with the understanding that it will not be used to limit or interpret the scope or meaning of the claims. The following claims are hereby incorporated into the detailed description, with each claim standing on its own as a separate embodiment.

What is claimed is:

1. A method comprising the steps of:
transmitting a broadcast wirelessly over a localized area, said broadcast comprising at least a computer-readable message indicating an availability of an information service, said broadcast being configured to be received and interpreted by at least one receiving device within said localized area;
receiving a response from said at least one receiving device for access to said information service;
connecting with said at least one receiving device; and
transmitting said information service to said at least one receiving device.

2. The method as recited in claim 1, in which said information service is stored locally.

3. The method as recited in claim 1, in which said information service at least comprises a computer executable application.

4. The method as recited in claim 1, in which said information service further comprises at least one instruction for directing said at least one receiving device to a globally accessible resource.

5. The method as recited in claim 1, further comprising the steps of determining a location of said at least one receiving device relative to a source of said broadcast transmission, in which said location is at least in part determined by a time of transmitting said broadcast and a time of receiving said response; and
denying access to said information service to said at least one receiving device having said location outside a predetermined proximity to said source.

6. The method as recited in claim 1, in which said information service further determines and utilizes a location of said at least one receiving device.

7. The method as recited in claim 3, in which said application comprises instruction enabling said receiving device to transmit said broadcast, receive said response from another receiving device, establish a connection with said another receiving device, and transmit said information service to said another receiving device.

8. The method as recited in claim 1, in which said information service further comprises at least a portion of a database.

9. The method as recited in claim 1, further comprising the step of receiving a request or data being sent by said at least one receiving device.

10. The method as recited in claim 1, in which said information service further comprises at least one instruction for storing data on said at least one receiving device.

11. The method as recited in claim 1, in which said at least one receiving device automatically executes said information service and displays any output of said information service.

12. The method as recited in claim 1, further comprising the step of determining a version and/or modification to the said information service to be transmitted based on at least in part a time, a type of said receiving device, an identity of said receiving device and external signals from other devices.

13. A system comprising:
a broadcasting device being configured to be operable to transmit a broadcast wirelessly over a localized area, said broadcast comprising at least a computer-readable message indicating an availability of an information service, said broadcasting device being further configured to be operable to receive a response to said broadcast, form a wireless connection over said localized area, and transmit said information service over said localized area; and
at least one receiving device being configured to be operable to receive and interpret said broadcast, and transmit said response to said broadcasting device to access said information service, said receiving device being further configured to be operable to establish a connection with said broadcasting device and receive said information service.

14. The system as recited in claim 13, further comprising the steps of determining a location of said at least one receiving device relative to a source of said broadcast transmission in which said location is at least in part determined by a time of transmitting said broadcast and a time of receiving said response, and denying access to said information service to said at least one receiving device having said location outside a predetermined proximity to said source, determining a version and/or modification to the said information service to be transmitted based on at least in part a time, type and identity of said receiving device and external signals from other devices, said information service being stored locally, said information service being configured to store data on said receiving device, transmit data or requests from said receiving device to said broadcasting device, determine and utilize a location of said receiving device, said information service at least comprising a computer executable application, said application comprising instructions for enabling said receiving device to transmit said broadcast, receive said response from another receiving device, establish a connection with said another receiving device, and transmit said information service to said another receiving device, said information service further comprising at least one instruction for directing said at least one receiving device to a globally accessible resource, said information service being further configured to automatically be executed by said receiving device and display of any output.

15. A non-transitory computer-readable storage medium with an executable program stored thereon, wherein the program instructs a processor to perform the following steps:
transmitting a broadcast wirelessly over a localized area, said broadcast comprising at least a computer-readable message indicating an availability of an information service, said broadcast being configured to be received and interpreted by at least one receiving device within said localized area;
receiving a response from said at least one receiving device for access to said information service;
connecting with said at least one receiving device; and
transmitting said information service to said at least one receiving device.

16. The program instructing the processor as recited in claim 15, in which said information service is stored locally.

17. The program instructing the processor as recited in claim 15, in which said information service at least comprises a computer executable application.

18. The program instructing the processor as recited in claim 15, in which said information service further comprises at least one instruction for directing said at least one receiving device to a globally accessible resource.

19. The program instructing the processor as recited in claim 15, further comprising the steps of determining a location of said at least one receiving device relative to a source of said broadcast transmission, in which said location is at least in part determined by a time of transmitting said broadcast and a time of receiving said response; and
denying access to said information service to said at least one receiving device having said location outside a predetermined proximity to said source.

20. The program instructing the processor as recited in claim 15, in which said information service further determines and utilizes a location of said at least one receiving device.

21. The program instructing the processor as recited in claim 17, in which said application comprises instruction enabling said receiving device to transmit said broadcast, receive said response from another receiving device, establish a connection with said another receiving device, and transmit said information service to said another receiving device.

22. The program instructing the processor as recited in claim 15, in which said information service further comprises at least a portion of a database.

23. The program instructing the processor as recited in claim 15, further comprising the step of receiving a request or data being sent by said at least one receiving device.

24. The program instructing the processor as recited in claim 15, in which said information service further comprises at least one instruction for storing data on said at least one receiving device.

25. The program instructing the processor as recited in claim 15, in which said at least one receiving device automatically executes said information service and displays any output of said information service.

26. The program instructing the processor as recited in claim 15, further comprising the step of determining a version and/or modification to said information service to be transmitted based on at least in part a time, a type of said receiving device, an identity of said receiving device and external signals from other devices.
